(19) United States
(12) Patent Application Publication
(10) Pub. No.: US 2026/0358181 A1
(43) Pub. Date: Nov. 12, 2026

(54) Variable Sensitivity Load Sensors

(71) Applicant: Textron Innovations Inc., Providence, RI (US)

(72) Inventors: Bryan Kenneth Baskin, Arlington, TX (US); Andrew Paul Haldeman, Richland Hills, TX (US)

(73) Assignee: Textron Innovations Inc., Providence, RI (US)

(21) Appl. No.: 19/202,845

(22) Filed: May 8, 2025

(51) Int. Cl. G01L 5/00; G01L 1/22

(52) U.S. Cl. CPC G01L 5/0019; G01L 1/22

(57) ABSTRACT

A load sensor includes a bearing housing having an inner ring, an outer ring and a flexure joint that integrally couples the inner ring to the outer ring. An annular sleeve is positioned between the inner ring and the outer ring. The annular sleeve is coupled to one of the inner ring and the outer ring. The annular sleeve forms an annular gap with the other of the inner ring and the outer ring. A bearing race is positioned radially interiorly of the bearing housing. A bearing element is rotatably positioned within the bearing race. At least one strain gauge is coupled to the flexure joint. A width of the annular gap is changed responsive to a radial load applied to the bearing element such that the flexure joint and the at least one strain gauge are deformed, thereby providing an indication of the presence of the radial load.

### GOVERNMENT RIGHTS

This invention was made with Government support under Agreement No. W58RGZ23-C-0001, awarded by the Army Contracting Command-Redstone Arsenal. The Government has certain rights in the invention.

### TECHNICAL FIELD OF THE DISCLOSURE

The present disclosure relates, in general, to sensing devices used to detect the presence, direction and/or magnitude of mechanical loads applied thereto and, in particular, to variable sensitivity load sensors that have higher sensitive in a minor radial load range and lower sensitive in a major radial load range.

### BACKGROUND

Vertical takeoff and landing (VTOL) aircraft are capable of taking off and landing without the need for a runway. One example of a VTOL aircraft is a helicopter which is a rotorcraft having one or more rotors that provide lift and thrust to the aircraft. The rotors not only enable hovering and vertical takeoff and landing, but also enable forward, backward and lateral flight. These attributes make helicopters highly versatile for use in congested, isolated or remote areas. Another example of a VTOL aircraft is a tiltrotor aircraft that includes a set of proprotors that can change their plane of rotation based on the operation being performed. Tiltrotor aircraft generate lift and forward propulsion using the proprotors that are typically coupled to nacelles mounted near the ends of a fixed wing. The nacelles rotate relative to the fixed wing such that the proprotors have a generally horizontal plane of rotation in a VTOL flight mode and a generally vertical plane of rotation while cruising in a forward flight mode, wherein the fixed wing provides lift and the proprotors provide forward thrust.

In modern fly-by-wire VTOL aircraft, the control logic used by the automatic flight control system may vary depending upon the mission and/or the maneuver being performed. For example, the control logic used during flight may be different from the control logic used when the aircraft is on the ground. Consequently, it is important for the automatic flight control system to know whether the aircraft is in the air or on the ground including when the aircraft transitions from being in the air to being on the ground during a landing maneuver. Attempts have been made to use various weight on wheel sensors, such as limit switches or proximity switches, to determine when the air-to-ground transition has taken place. It has been found, however, that conventional weight on wheel sensors require a significant ground vector load on the landing gear to obtain an on-the-ground indication which results in an undesirable delay in switching from the in-the-air control logic to the on-the-ground control logic. Accordingly, a need has arisen for an improved detection system that provides an early indication of the air-to-ground transition of a VTOL aircraft during a landing maneuver.

### SUMMARY

In a first aspect, the present disclosure is directed to a load sensor that include a bearing housing having an inner ring, an outer ring and a flexure joint that integrally couples the inner ring to the outer ring. An annular sleeve is positioned between the inner ring and the outer ring. The annular sleeve is coupled to one of the inner ring and the outer ring. The annular sleeve forms an annular gap with the other of the inner ring and the outer ring. A bearing race is positioned radially interiorly of the bearing housing. A bearing element is rotatably positioned within the bearing race. At least one strain gauge is coupled to the flexure joint. A width of the annular gap is changed responsive to a radial load applied to the bearing element such that the flexure joint and the at least one strain gauge are deformed, thereby providing an indication of the presence of the radial load.

In certain embodiments, the flexure joint may have a curvilinear cross section such as a uniform curvilinear cross section. In some embodiments, the annular sleeve may be coupled to the inner ring and may form the annular gap with the outer ring. In such embodiments, the inner ring may include a shoulder and the annular sleeve may be secured against the shoulder of the inner ring with a nut. In other embodiments, the annular sleeve may be coupled to the outer ring and may form the annular gap with the inner ring. In certain embodiments, the annular sleeve may be a non-segmented annular sleeve. In some embodiments, the at least one strain gauge may be coupled to a curved portion of the flexure joint. In other embodiments, the at least one strain gauge may be coupled to a straight portion of the flexure joint. In certain embodiments, the at least one strain gauge may be part of an array of redundant strain gauges. In other embodiments, the at least one strain gauge may be part of an array of complementary strain gauges such as an array of complementary strain gauges in a Wheatstone bridge configuration.

In some embodiments, the width of the annular gap may be reduced responsive to the radial load. In other embodiments, the width of the annular gap may be expanded responsive to the radial load. In certain embodiments, the at least one strain gauge may be at least one first strain gauge and at least one second strain gauge, a width of a first portion of the annular gap may be reduced responsive to the radial load such that the flexure joint and the at least one first strain gauge are deformed, a width of a second portion of the annular gap may be expanded responsive to the radial load such that the flexure joint and the at least one second strain gauge are deformed, and the deformation of the at least one first strain gauge and the at least one second strain gauge may collectively provide an indication of the presence of the radial load. In some embodiments, the at least one strain gauge may be part of an array of strain gauges distributed about the flexure joint and configured to provide directional load information. In certain embodiments, the load sensor may have a first sensitivity when the radial load is in a minor radial load range and a second sensitivity when the radial load is in a major radial load range with the radial load transitioning from the minor radial load range to the major radial load range when the radial load applied to the bearing element closes the annular gap in the direction of the radial load. In such embodiments, the first sensitivity may be higher than the second sensitivity.

In a second aspect, the present disclosure is directed to a landing gear assembly for an aircraft having an airframe. The landing gear assembly includes a landing strut having at least one wheel. First and second trunnion bearings are coupled to the airframe and are configured to pivotably receive the landing strut therebetween such that the landing strut has a plurality of positions relative to the airframe including a retracted position and an extended position. At least one of the trunnion bearings forms an on-the-ground detection sensor with each on-the-ground detection sensor including a bearing housing having an inner ring, an outer ring and a flexure joint that integrally couples the inner ring to the outer ring. An annular sleeve is positioned between the inner ring and the outer ring. The annular sleeve is coupled to one of the inner ring and the outer ring. The annular sleeve forms an annular gap with the other of the inner ring and the outer ring. A bearing race is positioned radially interiorly of the bearing housing. A bearing element is rotatably positioned within the bearing race. At least one strain gauge is coupled to the flexure joint. A width of the annular gap is changed responsive to a radial load applied to the bearing element such that the flexure joint and the at least one strain gauge are deformed, thereby providing an indication of the presence of the radial load.

In a third aspect, the present disclosure is directed to an aircraft such as a rotorcraft. The aircraft includes an airframe having first and second spars. A first trunnion bearing is coupled to the first spar and a second trunnion bearing is coupled to the second spar. A landing strut including at least one wheel is pivotable coupled between the first and second trunnion bearings such that the landing strut has a plurality of positions relative to the airframe including a retracted position and an extended position. At least one of the trunnion bearings forms an on-the-ground detection sensor with each on-the-ground detection sensor including a bearing housing having an inner ring, an outer ring and a flexure joint that integrally couples the inner ring to the outer ring. An annular sleeve is positioned between the inner ring and the outer ring. The annular sleeve is coupled to one of the inner ring and the outer ring. The annular sleeve forms an annular gap with the other of the inner ring and the outer ring. A bearing race is positioned radially interiorly of the bearing housing. A bearing element is rotatably positioned within the bearing race. At least one strain gauge is coupled to the flexure joint. A width of the annular gap is changed responsive to a radial load applied to the bearing element such that the flexure joint and the at least one strain gauge are deformed, thereby providing an indication of the presence of the radial load.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1B are schematic illustrations of a tiltrotor aircraft having at least one landing gear assembly with an on-the-ground detection system including a variable sensitivity load sensor in accordance with embodiments of the present disclosure;

FIGS. 2A-2B are schematic illustrations of a helicopter having at least one landing gear assembly with an on-the-ground detection system including a variable sensitivity load sensor in accordance with embodiments of the present disclosure;

FIGS. 3A-3D are schematic illustrations of a landing gear assembly for an aircraft with an on-the-ground detection system including variable sensitivity load sensors in accordance with embodiments of the present disclosure;

FIGS. 4A-4F are multiple views of a variable sensitivity load sensor in accordance with embodiments of the present disclosure;

FIG. 5A is a cross sectional view of a variable sensitivity load sensor in accordance with embodiments of the present disclosure;

FIGS. 5B-5E are cross sectional views of upper and lower portions of a variable sensitivity load sensor in unloaded and loaded states in accordance with embodiments of the present disclosure;

FIG. 6A is a cross sectional view of a variable sensitivity load sensor in accordance with embodiments of the present disclosure;

FIGS. 6B-6E are cross sectional views of upper and lower portions of a variable sensitivity load sensor in unloaded and loaded states in accordance with embodiments of the present disclosure; and FIG. 7 is a strain versus load graph for a variable sensitivity load sensor in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

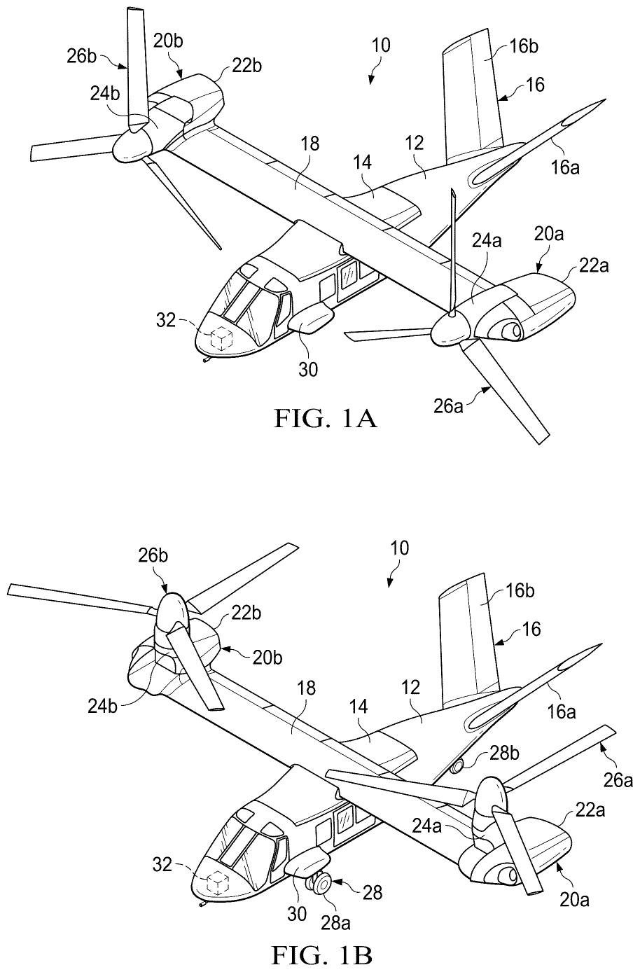

Referring to FIGS. 1A-1B in the drawings, an aircraft depicted as rotorcraft and more particularly as a tiltrotor aircraft is schematically illustrated and generally designated 10. Aircraft 10 includes a fuselage 12, a wing mount assembly 14 and a tail assembly 16 including tail members 16a, 16b having control surfaces operable for horizontal and/or vertical stabilization during forward flight. A wing member 18 is supported by wing mount assembly 14. Located at outboard ends of wing member 18 are propulsion assemblies 20a, 20b. Propulsion assembly 20a includes a nacelle depicted as fixed pylon 22a that houses an engine and transmission. In addition, propulsion assembly 20a includes a mast assembly 24a that is tiltable relative to fixed pylon 22a between a generally horizontal orientation, as best seen in FIG. 1A, and a generally vertical orientation, as best seen in FIG. 1B. Propulsion assembly 20a also includes a proprotor assembly 26a that is rotatable relative to mast assembly 24a responsive to torque and rotational energy provided via a drive system mechanically coupled to the engine and transmission. Likewise, propulsion assembly 20b includes a nacelle depicted as fixed pylon 22b that houses an engine and transmission, a mast assembly 24b that is tiltable relative to fixed pylon 22b and a proprotor assembly 26b that is rotatable relative to mast assembly 24b responsive to torque and rotational energy provided via a drive system mechanically coupled to the engine and transmission.

Aircraft 10 includes a landing gear system 28 depicted as including a pair of forward landing gear assemblies with only the left forward landing gear assembly 28a being visible and an aft landing gear assembly 28b. In the illustrated embodiment, aircraft 10 includes a pair of sponsons with only the left sponson 30 being visible. Sponson 30 provides airframe structure for pivotably supporting landing gear assembly 28a such that landing gear assembly 28a has a plurality of positions relative to sponson 30 including a retracted position, as best seen in FIG. 1A, for flight operations and an extended position, as best seen in FIG. 1B, for landing and ground operations. Landing gear system 28 includes one or more on-the-ground detection sensors in the form of variable sensitivity load sensors of the present disclosure. Each of the on-the-ground detection sensors is preferably linked to a flight control system 32 that executes control logic to provide commands to operate the fly-by-wire control system of aircraft 10. As the control logic used during flight is different from the control logic used when aircraft 10 is on the ground, the on-the-ground detection sensors incorporated into landing gear system 28 provide an early indication of the air-to-ground transition of aircraft 10 during landing maneuvers such that the proper control logic may be executed by flight control system 32.

FIG. 1A illustrates aircraft 10 in airplane or forward flight mode, in which proprotor assemblies 26a, 26b are rotating in a substantially vertical plane to provide a forward thrust enabling wing member 18 to provide a lifting force responsive to forward airspeed, such that aircraft 10 flies much like a conventional propeller driven aircraft. FIG. 1B illustrates aircraft 10 in helicopter or VTOL flight mode, in which proprotor assemblies 26a, 26b are rotating in a substantially horizontal plane to provide a lifting thrust, such that aircraft 10 flies much like a conventional helicopter. It should be appreciated that aircraft 10 can be operated such that proprotor assemblies 26a, 26b are selectively positioned between forward flight mode and VTOL flight mode, which can be referred to as a conversion flight mode.

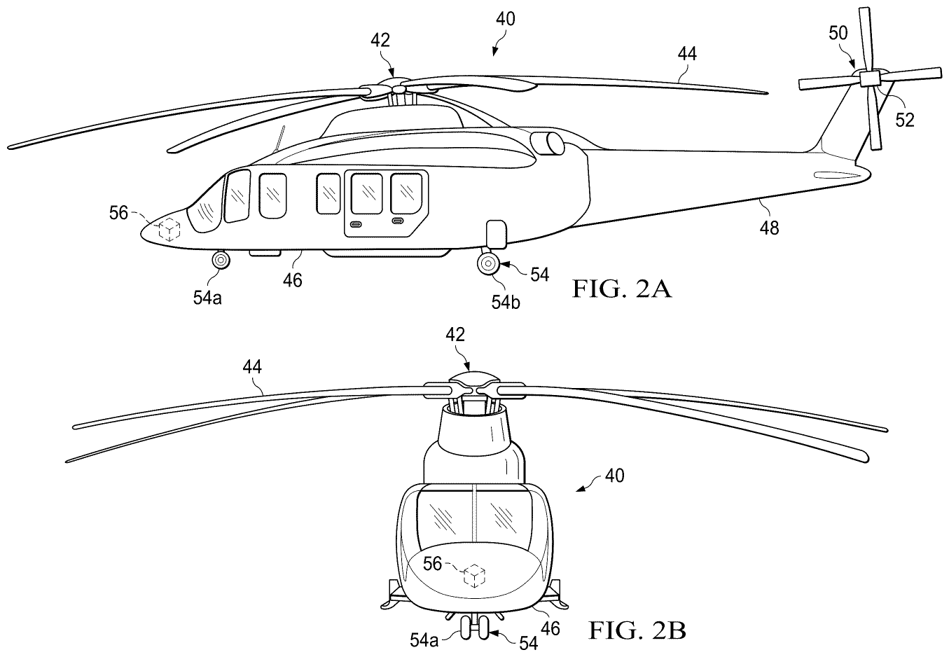

Referring to FIGS. 2A-2B in the drawings, an aircraft depicted as rotorcraft and more particularly as a helicopter is schematically illustrated and generally designated 40. The primary propulsion assembly of helicopter 40 is a main rotor assembly 42 powered by one or more engines via a main rotor gearbox. Main rotor assembly 42 includes a plurality of rotor blade assemblies 44 extending radially outward from a main rotor hub. Main rotor assembly 42 is coupled to a fuselage 46 and is rotatable relative thereto. The pitch of rotor blade assemblies 44 can be collectively and/or cyclically manipulated to selectively control direction, thrust and lift of helicopter 40. A tailboom 48 extends from fuselage 46 in the aft direction. An anti-torque system 50 includes a tail rotor 52 that is rotatably coupled to the aft portion of tailboom 48. Anti-torque system 50 controls the yaw of helicopter 40. Helicopter 40 includes a landing gear system 54 including a forward landing gear assembly 54a and a pair of aft landing gear assemblies with only left aft landing gear assembly 54b being visible. Landing gear system 54 includes one or more on-the-ground detection sensors in the form of variable sensitivity load sensors of the present disclosure. Each of the on-the-ground detection sensors is preferably linked to a flight control system 56 that executes control logic to provide commands to operate the fly-by-wire control system of helicopter 40. As the control logic used during flight is different from the control logic used when helicopter 40 is on the ground, the on-the-ground detection sensors incorporated into landing gear system 54 provide an early indication of the air-to-ground transition of helicopter 40 during landing maneuvers such that the proper control logic is executed by flight control system 56. Each of the landing gear assemblies of landing gear system 54 is coupled to the airframe of aircraft 40 and is rotatable relative thereto between a plurality of positions including retracted positions for flight operations and extended positions for landing and ground operations.

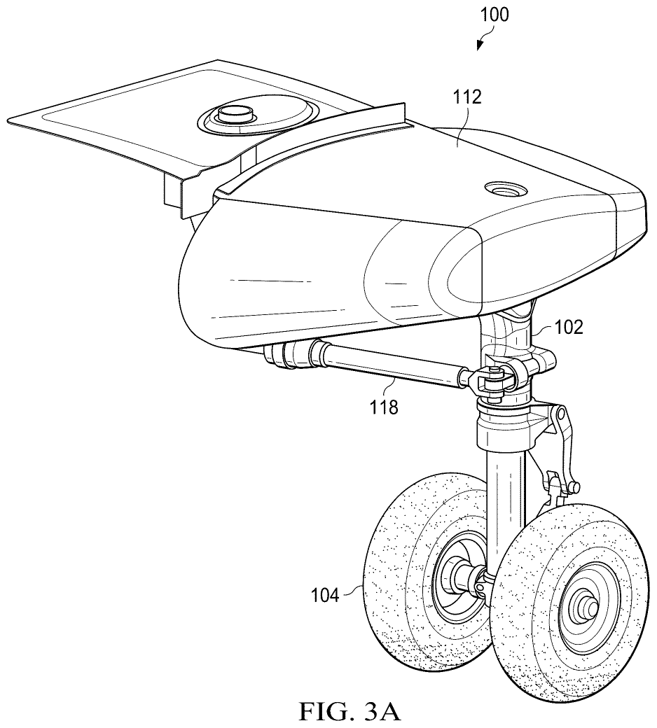

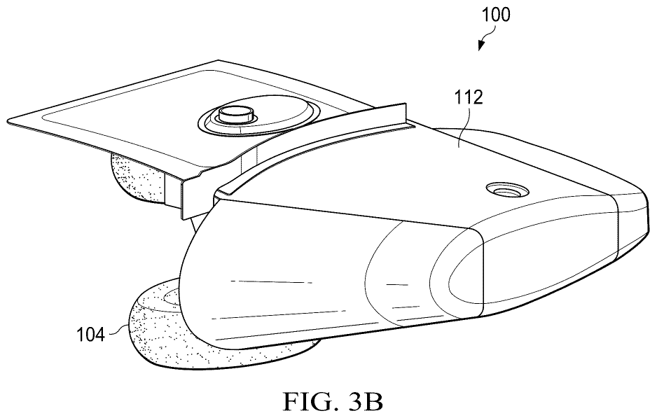

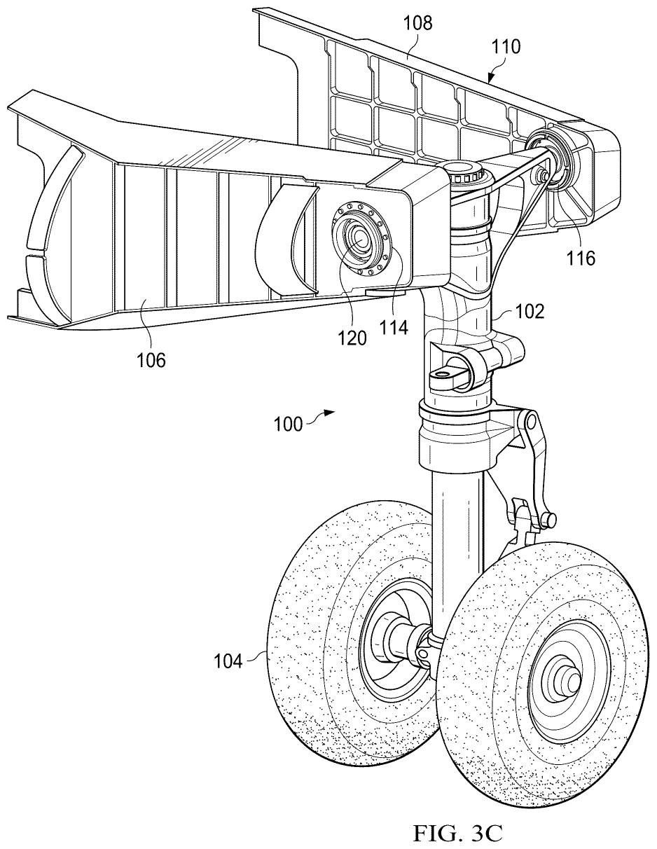

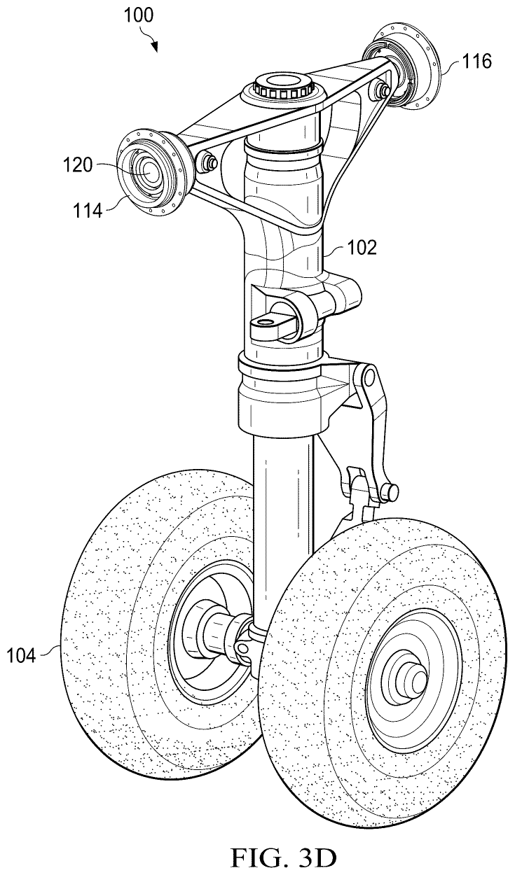

Referring now to FIGS. 3A-3D in the drawings, a landing gear assembly is schematically illustrated and generally designated 100. Landing gear assembly 100 is representative of landing gear assemblies 28a, 28b, 54a, 54b discussed herein. In the illustrated embodiment, landing gear assembly 100 includes a landing strut 102 having a pair of wheels 104 on a distal end thereof. The proximal end of landing strut 102 is pivotably coupled to an airframe structure depicted as a forward spar 106 and an aft spar 108 that form a sponson airframe 110 having a cowling 112 positioned therearound. More specifically, landing strut 102 is pivotably coupled to forward spar 106 via a forward trunnion bearing depicted as variable sensitivity load sensor 114 and to aft spar 108 via an aft trunnion bearing depicted as variable sensitivity load sensor 116. Landing gear assembly 100 includes an actuation mechanism 118 that is configured operate landing strut 102 between a plurality of positions relative to sponson airframe 110 including an extended position, as best seen in FIG. 3A, for landing and ground operations and a retracted position, as best seen in FIG. 3B, for flight operations. Retracting landing strut 102 and wheels 104 into the body of the aircraft for flight operations tends to improve the aerodynamics of the aircraft during flight. Landing strut 102 is pivotably coupled to variable sensitivity load sensor 114 via a forward pivot pin 120 and is pivotably coupled to variable sensitivity load sensor 116 via an aft pivot pin (not visible). In the illustrated embodiment, variable sensitivity load sensor 114 is coupled to forward spar 106 using a plurality of bolts, as best seen in FIG. 3C. Likewise, variable sensitivity load sensor 116 is coupled to aft spar 108 using a plurality of bolts. In other embodiments, a variable sensitivity load sensor may be coupled to forward and aft spars using, for example, a spanner nut or other suitable means.

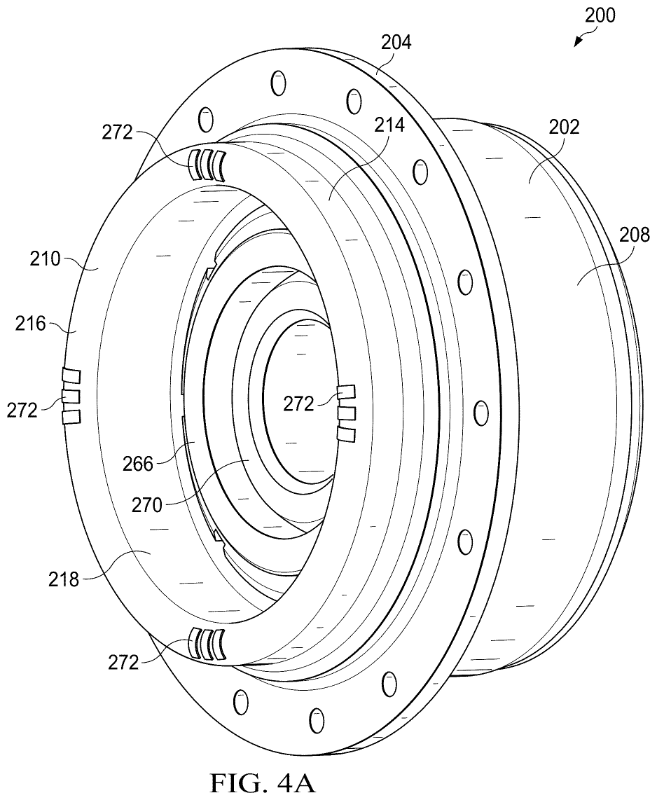

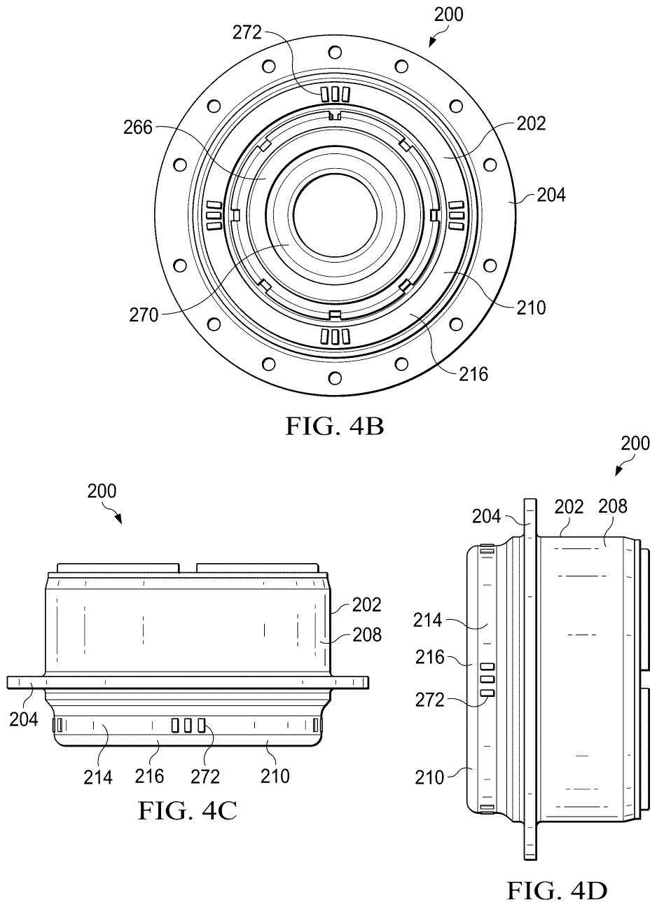

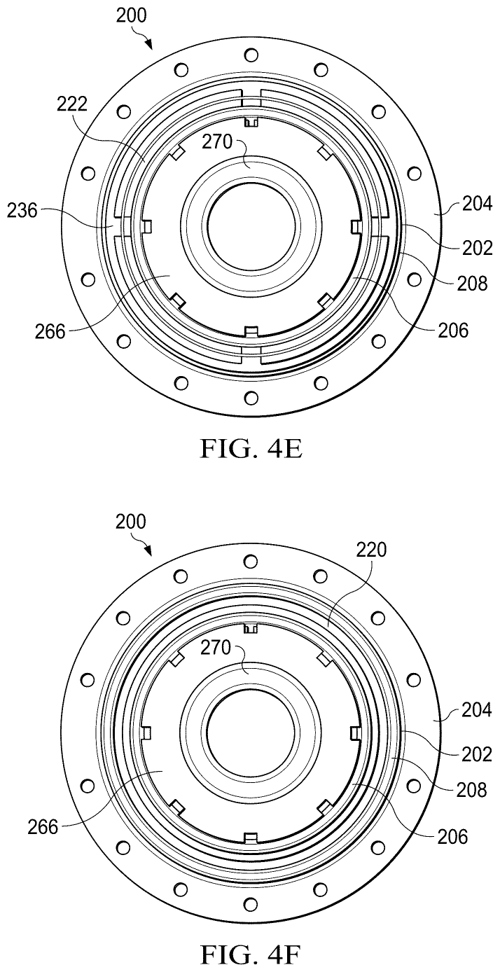

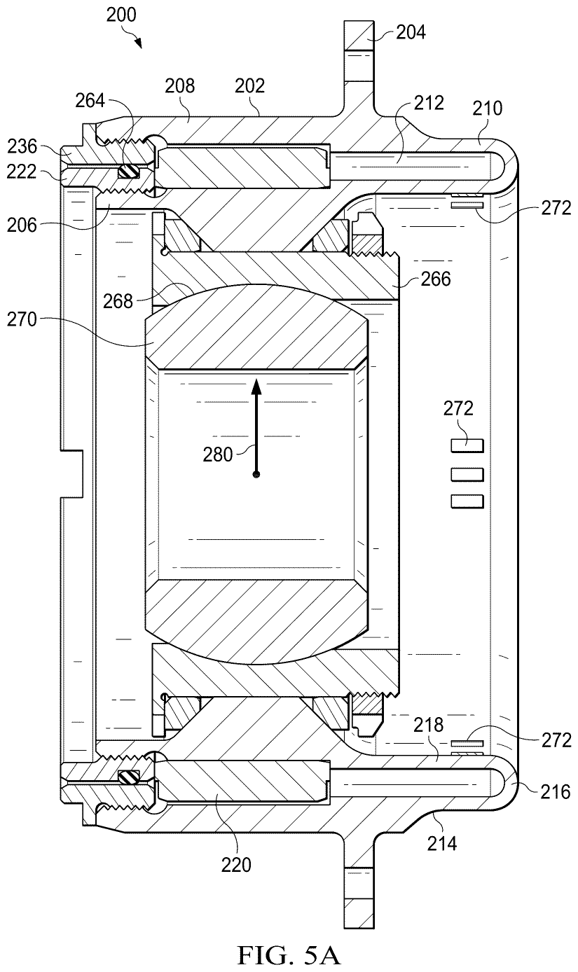

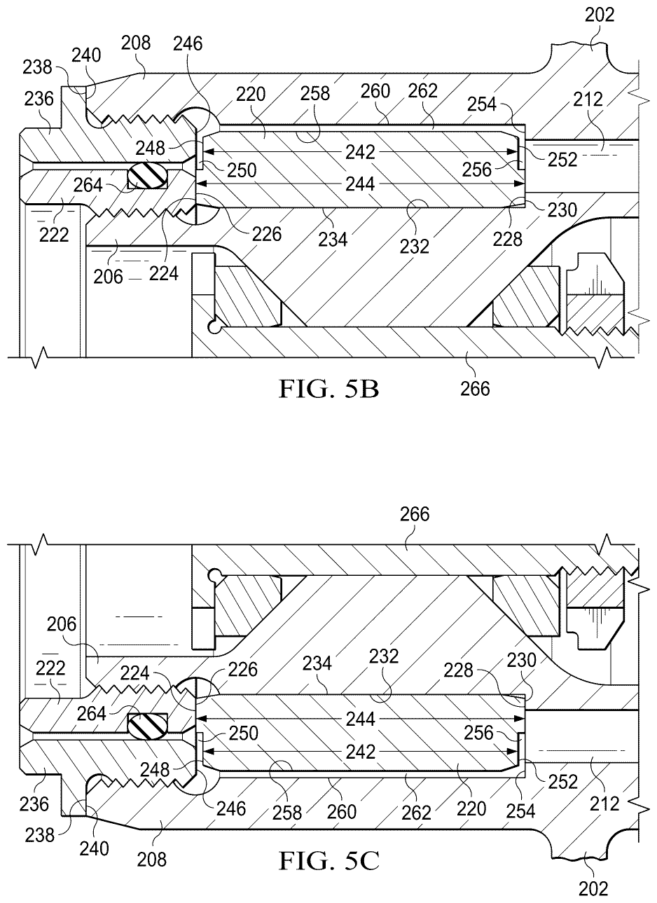

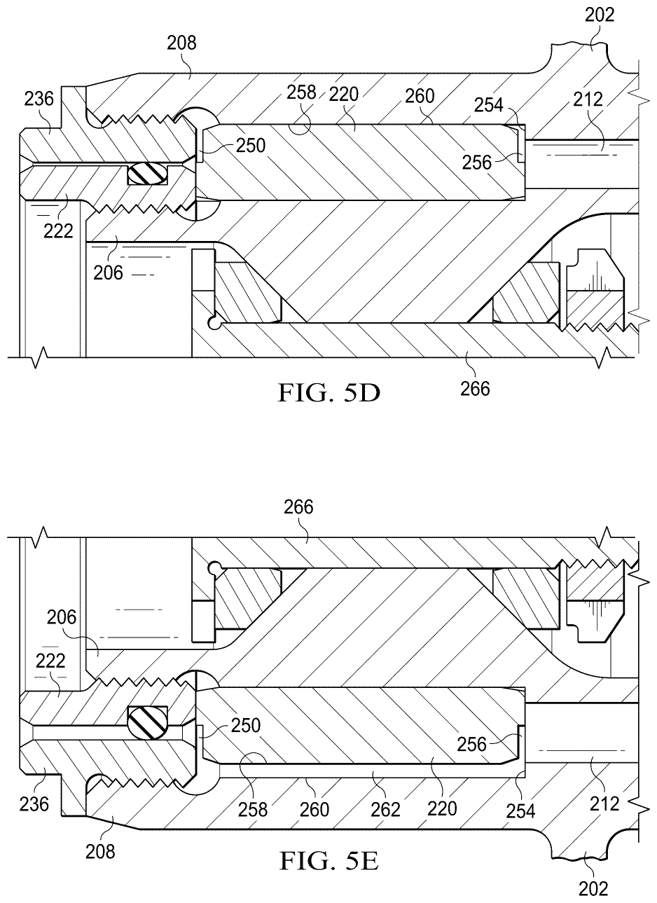

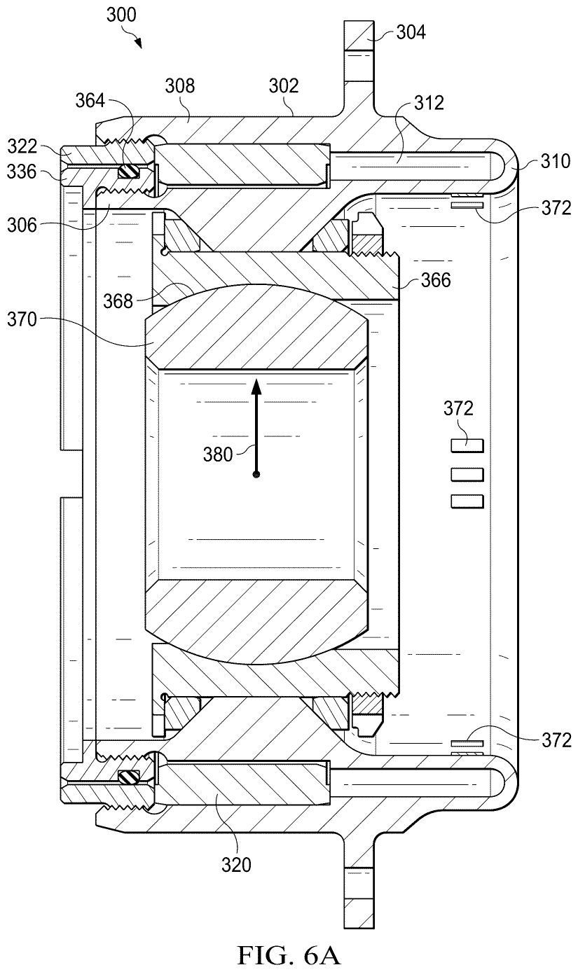

Referring additionally to FIGS. 4A-4F in the drawings, details regarding a variable sensitivity load sensor 200 will be discussed. Variable sensitivity load sensor 200 is representative of variable sensitivity load sensors 114, 116 and may be used in the landing gear systems of an aircraft, such as aircraft 10, 40, as an on-the-ground detection sensor. In the illustrated embodiment, variable sensitivity load sensor 200 includes a bearing housing 202 having an integral flange 204 with a bolt pattern formed therein such that variable sensitivity load sensor 200 may be coupled to a structure, such as an airframe structure, using a plurality of bolts. Bearing housing 202 includes an inner ring 206, an outer ring 208 and a flexure joint 210 that integrally couples inner ring 206 to outer ring 208 (see also FIG. 5A). Bearing housing 202 may be formed from a metal such as stainless steel or aluminum. In the illustrated embodiment, an annular cavity 212 is formed within bearing housing 202 between inner ring 206 and outer ring 208. A distal end of annular cavity 212 is defined by flexure joint 210. In the illustrated embodiment, the cross section of flexure joint 210 has an outer straight section 214, a curvilinear section 216 and an inner straight section 218, as best seen in FIG. 5A. Outer straight section 214 may be described as an outer ring of flexure joint 210 that is integrally joined with outer ring 208. Inner straight section 218 may be described as an inner ring of flexure joint 210 that is integrally joined with inner ring 206. Curvilinear section 216 integrally couples the outer ring of flexure joint 210 to the inner ring of flexure joint 210. In the illustrated embodiment, curvilinear section 216 has a uniform radius of curvature such that flexure joint 210 may be described as having a uniform curvilinear cross section.

Variable sensitivity load sensor 200 includes an annular sleeve 220 that is positioned within annular cavity 212 between inner ring 206 and outer ring 208. Annular sleeve 220 may be formed from a metal such as a bronze or other copper alloy or an aluminum such as an anodized or a hard anodized aluminum. In the illustrated embodiment, annular sleeve 220 is a non-segmented annular sleeve. Annular sleeve 220 is nonrotatably coupled to bearing housing 202 using an inner nut depicted as a spanner nut 222. More specifically, when inner nut 222 is threadably coupled to inner ring 206, a lateral face 224 of inner nut 222 contacts a corresponding lateral face 226 of annular sleeve 220 which secures an opposite lateral face 228 of annular sleeve 220 against an annular shoulder 230 of inner ring 206, as best seen in FIGS. 5B-5C. Note the FIG. 5B is an enlarged view of an upper portion of variable sensitivity load sensor 200 of FIG. 5A and FIG. 5C is an enlarged view of a lower portion of variable sensitivity load sensor 200 of FIG. 5A. Annular sleeve 220 is sized such that an inner surface 232 of annular sleeve 220 is in contact with an outer surface 234 of inner ring 206. For example, annular sleeve 220 and inner ring 206 may be described as having a contact relationship such as a close fitting relationship or a friction fit relationship.

Variable sensitivity load sensor 200 includes an outer nut depicted as a spanner nut 236. When outer nut 236 is threadably coupled to outer ring 208, a lateral face 238 of outer nut 236 contacts a corresponding lateral face 240 of outer ring 208. The hard stop for outer nut 236 against outer ring 208 prevents outer nut 236 from contacting annular sleeve 220. Annular sleeve 220 is shaped such that the radially outer portion of annular sleeve 220 has a width 242 that is less than a width 244 of the radially inner portion of annular sleeve 220. The reduced width region 242 prevents contact between a lateral face 246 of outer nut 236 and a lateral face 248 of annular sleeve 220 which form a gap 250 therebetween. Likewise, the reduced width region 242 prevents contact between a lateral face 252 of annular sleeve 220 and an annular shoulder 254 of outer ring 208 which form a gap 256 therebetween. Annular sleeve 220 is sized such that an outer surface 258 of annular sleeve 220 does not contact an inner surface 260 of outer ring 208 forming an annular gap 262 therebetween. An O-ring seal 264 is positioned between inner nut 222 and outer nut 236.

Variable sensitivity load sensor 200 includes a bearing race 266 that is positioned radially interiorly of bearing housing 202 and more specifically radially interiorly of inner ring 206. Bearing race 266 is non-rotatably coupled bearing housing 202. In the illustrated embodiment, bearing race 266 has an inner spherically surface 268 that is sized to receive a spherical bearing element 270 therein such that bearing element 270 is rotatable within bearing race 266 to provide, for example, trunnion bearing functionality for a landing gear assembly to operate between extended and retracted positions. In other embodiments, bearing element 270 may be a journal bearing element, a plain bearing element or other suitable bearing element type, depending upon the specific implementation.

Variable sensitivity load sensor 200 includes one or more strain gauges 272 that are coupled to flexure joint 210. In FIGS. 4A-4B, an array of strain gauges 272 are coupled to curvilinear section 216 of flexure joint 210. In the illustrated embodiment, redundant strain gauges are placed in each quadrant of variable sensitivity load sensor 200; namely, three redundant strain gauges 272 in an upper quadrant, three redundant strain gauges 272 in a lower quadrant, three redundant strain gauges 272 in a first side quadrant and three redundant strain gauges 272 in a second side quadrant. The use of redundant strain gauges in each spatial region increases the reliability, safety and system availability by duplicating the strain gauge functionality such that if one or more strain gauges fail, another strain gauge provides the required data ensuring continuous operation and minimal downtime.

Having strain gauges 272 in opposing quadrants enables multiple strain gauges 272 to operate as an array of complementary strain gauges. As explained herein, when a radial load is applied to variable sensitivity load sensor 200, the strain gauges on opposites sides of flexure joint 210 will experience opposite types of strain. For example, in the case of uniaxial strain gauges and a radial load in the positive vertical direction, strain gauges 272 mounted in the upper quadrant experience elongation or tensile strain causing an increase in the resistance of the conductive material while strain gauges 272 mounted in the lower quadrant experience contraction or compressive strain causing a decrease in the resistance of the conductive material. As such, strain gauges 272 mounted in the upper quadrant and/or strain gauges 272 mounted in the lower quadrant may be used independently or collectively to determine the presence and/or the magnitude of a radial load in the positive vertical direction. Including strain gauges 272 from both the upper quadrant and the lower quadrant in the same circuit, such as in a Wheatstone bridge configuration, can provide benefits in terms of accuracy, sensitivity and temperature compensation. Likewise, in the case of a radial load in a lateral direction, strain gauges 272 mounted in the first side quadrant and/or strain gauges 272 mounted in the second side quadrant may be used independently or collectively to determine the presence and/or the magnitude of the lateral load.

While having strain gauges 272 in a single quadrant or in opposing quadrants provides data regarding the presence and/or the magnitude of a radial load applied to variable sensitivity load sensor 200, having strain gauges 272 in non-opposing quadrants enables strain gauges 272 to provide data that can be used to determine the directionality of the radial load. For example, taking data from an upper/lower quadrant Wheatstone bridge and data from a first side/second side quadrant Wheatstone bridge can be used to determine not only the existence and magnitude of the radial load but also, the direction of the radial load applied to variable sensitivity load sensor 200. It is noted that a load vector applied to variable sensitivity load sensor 200 may be applied in a direction other than a radial direction in which case the radial load discussed herein will represent the component of the load vector in the radial direction.

While placing strain gauges 272 on curvilinear section 216 of flexure joint 210 provides desired strain gauge responses to applied loads, strain gauges 272 could alternatively be coupled to other locations on flexure joint 210 such as outer straight section 214, as best seen in FIGS. 4C-4D, or inner straight section 218, as best seen in FIG. 5A, so long as strain gauges 272 experience strain responsive to radial loads applied to variable sensitivity load sensor 200. In addition, even though strain gauges 272 have been depicted as triply redundant strain gauges, it should be understood by those having ordinary skill in the art that a variable sensitivity load sensor of the present disclosure could have other numbers of redundant or non-redundant strain gauges both greater than or less than three including, for example, a single strain gauge. Further, even though strain gauges 272 have been depicted as being circumferentially distributed at ninety degree intervals about flexure joint 210, it should be understood by those having ordinary skill in the art that a variable sensitivity load sensor of the present disclosure could have other orientations of strain gauges that have uniform or nonuniform circumferential distributions at intervals both greater than or less than ninety degrees. Also, even though strain gauges 272 have been depicted as being positioned in common locations on flexure joint 210, it should be understood by those having ordinary skill in the art that a variable sensitivity load sensor of the present disclosure could strain gauges positioned in multiple location such as a variable sensitivity load sensor having strain gauges 272 located on two or more of outer straight section 214, curvilinear section 216 and inner straight section 218 of flexure joint 210.

Referring additionally to FIGS. 5A-5E in the drawings, the reaction of variable sensitivity load sensor 200 to a linear force 280 being applied to bearing element 270, such as by a pivot pin of a landing gear assembly, is depicted. It is note that the movement of the components within variable sensitivity load sensor 200 has been idealized and exaggerated to better illustrate the inventive principles. FIG. 5B-5C represent variable sensitivity load sensor 200 prior to the application of linear force 280 and FIGS. 5D-5E represent variable sensitivity load sensor 200 during the application of linear force 280. It is noted that in the case of a landing gear assembly, the linear force would be a ground vector load created when the wheels come in contact with the ground. The ground vector load is transmitted from the landing gear wheels to variable sensitivity load sensor 200 via the landing strut and the pivot pin. When linear force 280 is applied to bearing element 270, variable sensitivity load sensor 200 experiences a radial load applied in the positive vertical direction that is reacted by bearing housing 202 which is coupled to airframe structure. As best seen in the comparison of FIGS. 5B and 5D, the top side of bearing housing 202 has a compressive load applied thereto as bearing element 270 translates upwardly. This motion causes the width of the portion of annular gap 262 in the direction of the radial load to reduce and eventually close, as indicated by outer surface 258 of annular sleeve 220 being in contact with inner surface 260 of outer ring 208 in FIG. 5D. Annular sleeve 220 is free to move relative to outer nut 236 due to gap 250 and is free to move relative to annular shoulder 254 due to gap 256. As the width of annular gap 262 reduces, the portion of flexure joint 210 in the direction of the radial load and the associated strain gauges 272 are deformed. The tensile strain detected by strain gauges 272 indicates the presence of linear force 280. In the present example of a ground vector load being transmitted from the landing gear wheels to variable sensitivity load sensor 200, the tensile strain detected by strain gauges 272 would be indicative of the on-the-ground status of the aircraft providing, for example, an early indication of when the aircraft has transitioned from an in-the-air condition to an on-the-ground condition during a landing maneuver.

As best seen in the comparison of FIGS. 5C and 5E, the bottom side of bearing housing 202 has a tensile load applied thereto as bearing element 270 translates upwardly. This motion causes the width of the portion of annular gap 262 opposite the direction of the radial load to expand, as indicated by the greater width of annular gap 262 between outer surface 258 of annular sleeve 220 and inner surface 260 of outer ring 208 in FIG. 5E. Annular sleeve 220 is free to move relative to outer nut 236 due to gap 250 and is free to move relative to annular shoulder 254 due to gap 256. As the width of annular gap 262 expands, the portion of flexure joint 210 opposite the direction of the radial load and the associated strain gauges 272 are deformed. The compressive strain detected by strain gauges 272 indicates the presence of linear force 280. In the present example of a ground vector load being transmitted from the landing gear wheels to variable sensitivity load sensor 200, the compressive strain detected by strain gauges 272 would be indicative of the on-the-ground status of the aircraft providing, for example, an early indication of when the aircraft has transitioned from an in-the-air condition to an on-the-ground condition during a landing maneuver. Together, strain gauges 272 proximate the portion of flexure joint 210 in the direction of the radial load and strain gauges 272 proximate the portion of flexure joint 210 opposite the direction of the radial load may individually or collectively, such as in a Wheatstone bridge configuration, detect strains caused by changes in corresponding annular gap widths to provide an early indication of aircraft ground status.

Conventional weight on wheel sensors used to determine when the air-to-ground transition of a VTOL aircraft has taken place, such as limit switches or proximity switches, typically provide an indication of the on-the-ground condition when the landing gear has experienced a significant ground vector load. It has been found, however, that in modern fly-by-wire VTOL aircraft, waiting until this significant load has occurred results in an undesirable delay in switching from the in-the-air control logic to the on-the-ground control logic. The present embodiments solve this problem by positioning one or more variable sensitivity load sensors in the landing gear system that utilize detected strain in flexure joints of trunnion bearings to identify the presence of the ground vector load. In this unique configuration, a comparatively small ground vector load can be detected enabling the on-the-ground detection sensors of the present disclosure to provide an early indication to the flight control system that the aircraft has transitioned from an in-the-air condition to an on-the-ground condition, thereby enabling the flight control system to transition from the in-the-air control logic to the on-the-ground control logic in a more timely manner.

In the event that variable sensitivity load sensor 200 experiences axial loads, such as loads in the leftward or rightward direction in FIG. 5A, gap 250 and/or gap 256 will tend to close responsive to the axial load. In the illustrated embodiment, gap 250 and gap 256 are sized to provide hard stops for annular sleeve 220 against lateral face 246 of outer nut 236 and/or annular shoulder 254 of outer ring 208. By limiting the axial movement of annular sleeve 220 relative to outer ring 208, excess stress on flexure joint 210 is prevented, thereby reducing the likelihood of damage or overload on flexure joint 210 when variable sensitivity load sensor 200 experiences axial loads.

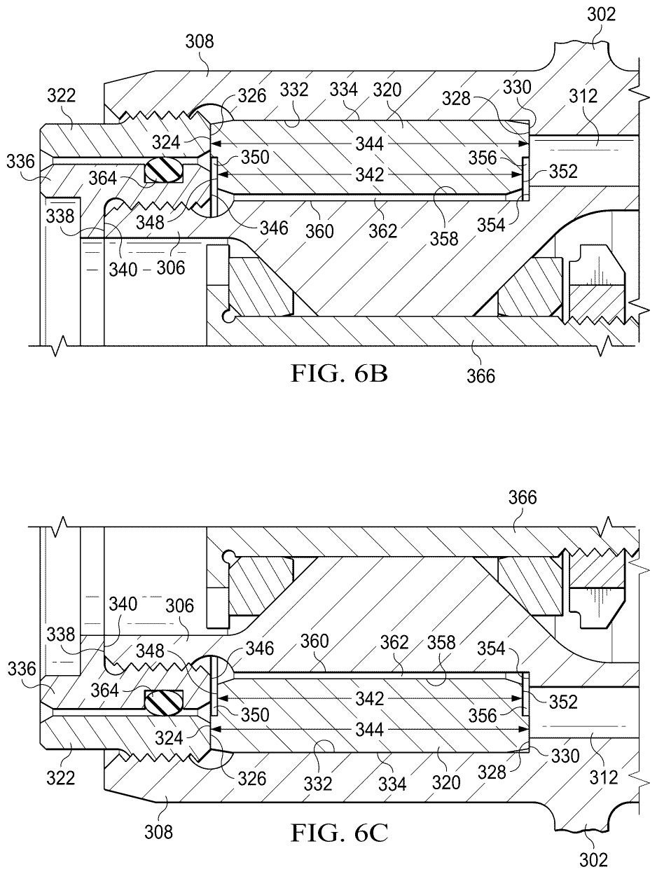

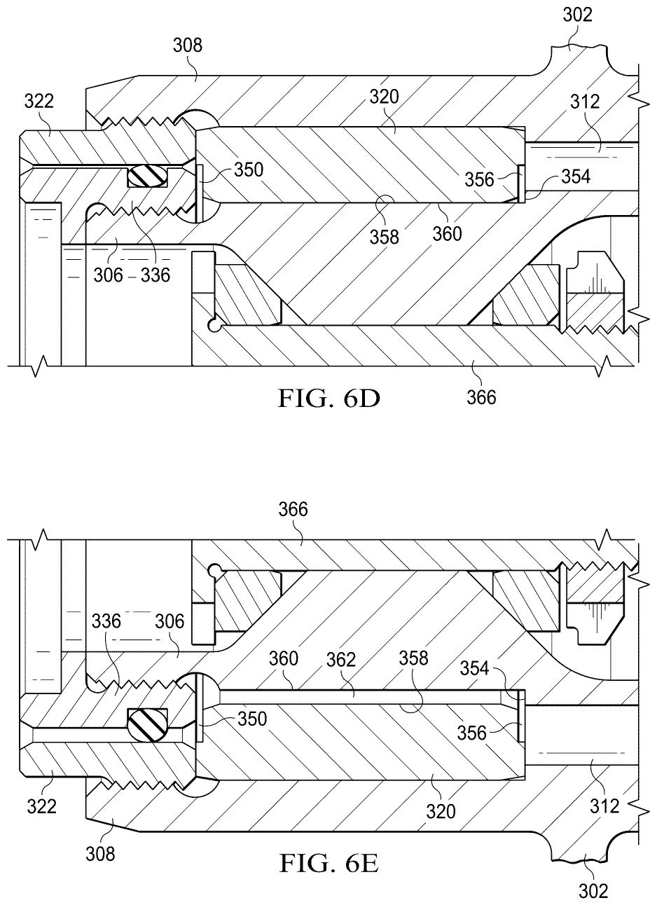

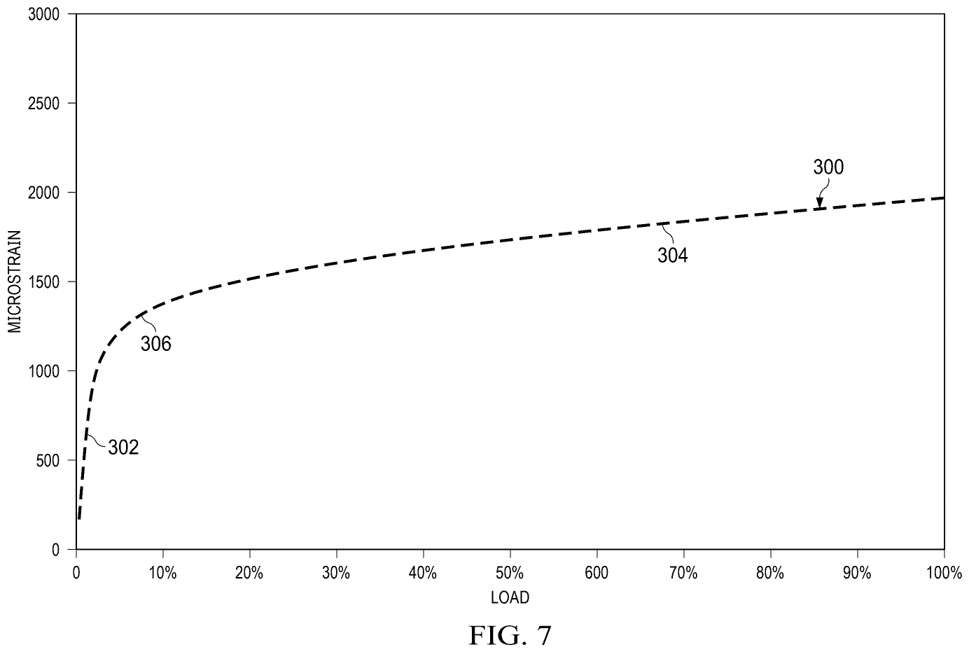

Referring additionally to FIGS. 6A-6E in the drawings, the reaction of variable sensitivity load sensor 300 to a linear force 380 in the positive vertical direction being applied to bearing element 370, such as by a pivot pin of a landing gear assembly, is depicted. FIG. 6B-6C represent variable sensitivity load sensor 300 prior to the application of linear force 380 and FIGS. 6D-6E represent variable sensitivity load sensor 300 during the application of linear force 380. Variable sensitivity load sensor 300 is representative of variable sensitivity load sensors 114, 116 and may be used in the landing gear systems of an aircraft, such as aircraft 10, 40, as an on-the-ground detection sensor. As variable sensitivity load sensor 300 is similar to variable sensitivity load sensor 200, similar parts will be denoted with reference characters incremented to a 300 series while maintaining the same tens and ones digits. Variable sensitivity load sensor 300 includes a bearing housing 302 having an integral flange 304. Bearing housing 302 includes an inner ring 306, an outer ring 308 and a flexure joint 310 that integrally couples inner ring 306 to outer ring 308. In the illustrated embodiment, an annular cavity 312 is formed within bearing housing 302 between inner ring 306 and outer ring 308. A distal end of annular cavity 312 is defined by flexure joint 310.

Variable sensitivity load sensor 300 includes a bearing race 366 that is non-rotatably coupled bearing housing 302. In the illustrated embodiment, bearing race 366 has an inner spherically surface 368 that is sized to receive a spherical bearing element 370 therein such that bearing element 370 is rotatable within bearing race 366 to provide, for example, trunnion bearing functionality for a landing gear assembly to operate between extended and retracted positions. Variable sensitivity load sensor 300 includes one or more strain gauges 372 that are coupled to flexure joint 310. Strain gauges 372 may operate as independent strain gauges, as one or more arrays of redundant strain gauges, as one or more arrays of complementary strain gauges or in any other suitable configuration and/or orientation.

Variable sensitivity load sensor 300 includes an annular sleeve 320 that is positioned within annular cavity 312 between inner ring 306 and outer ring 308. Annular sleeve 320 is nonrotatably coupled to bearing housing 302 using an outer nut depicted as a spanner nut 322. More specifically, when outer nut 322 is threadably coupled to outer ring 308, a lateral face 324 of outer nut 322 contacts a corresponding lateral face 326 of annular sleeve 320 which secures an opposite lateral face 328 of annular sleeve 320 against an annular shoulder 330 of outer ring 308, as best seen in FIGS. 6B-6C. Annular sleeve 320 is sized such that an outer surface 332 of annular sleeve 320 is in contact with an inner surface 334 of outer ring 308. For example, annular sleeve 320 and outer ring 308 may be described as having a contact relationship such as a close fitting relationship or a friction fit relationship.

Variable sensitivity load sensor 300 includes an inner nut depicted as a spanner nut 336. When inner nut 336 is threadably coupled to inner ring 306, a lateral face 338 of inner nut 336 contacts a corresponding lateral face 340 of inner ring 306. The hard stop for inner nut 336 against inner ring 306 prevents inner nut 336 from contacting annular sleeve 320. Annular sleeve 320 is shaped such that the radially inner portion of annular sleeve 320 has a width 342 that is less than a width 344 of the radially outer portion of annular sleeve 320. The reduced width region 342 prevents contact between a lateral face 346 of inner nut 336 and a lateral face 348 of annular sleeve 320 which form a gap 350 therebetween. Likewise, the reduced width region 342 prevents contact between a lateral face 352 of annular sleeve 320 and an annular shoulder 354 of inner ring 306 which form a gap 356 therebetween. Annular sleeve 320 is sized such that an inner surface 358 of annular sleeve 320 does not contact an outer surface 360 of inner ring 306 forming an annular gap 362 therebetween. An O-ring seal 364 is positioned between outer nut 322 and inner nut 336.

When linear force 380 is applied to bearing element 370, variable sensitivity load sensor 300 experiences a radial load applied in the positive vertical direction that is reacted by bearing housing 302. As best seen in the comparison of FIGS. 6B and 6D, the top side of bearing housing 302 has a compressive load applied thereto as bearing element 370 translates upwardly. This motion causes the width of the portion of annular gap 362 in the direction of the radial load to reduce and eventually close, as indicated by inner surface 358 of annular sleeve 320 being in contact with outer surface 360 of inner ring 306 in FIG. 6D. Annular sleeve 320 is free to move relative to inner nut 336 due to gap 350 and is free to move relative to annular shoulder 354 due to gap 356. As the width of annular gap 362 reduces, the portion of flexure joint 310 in the direction of the radial load and the associated strain gauges 372 are deformed. The tensile strain detected by strain gauges 372 indicates the presence of linear force 380. In the present example of a ground vector load being transmitted from the landing gear wheels to variable sensitivity load sensor 300, the tensile strain detected by strain gauges 372 would be indicative of the on-the-ground status of the aircraft providing, for example, an early indication of when the aircraft has transitioned from an in-the-air condition to an on-the-ground condition during a landing maneuver.

As best seen in the comparison of FIGS. 6C and 6E, the bottom side of bearing housing 302 has a tensile load applied thereto as bearing element 370 translates upwardly. This motion causes the width of the portion of annular gap 362 opposite the direction of the radial load to expand, as indicated by the greater width of annular gap 362 between inner surface 358 of annular sleeve 320 and outer surface 360 of inner ring 306 in FIG. 6E. Annular sleeve 320 is free to move relative to inner nut 336 due to gap 350 and is free to move relative to annular shoulder 354 due to gap 356. As the width of annular gap 362 expands, the portion of flexure joint 310 opposite the direction of the radial load and the associated strain gauges 372 are deformed. The compressive strain detected by strain gauges 372 indicates the presence of linear force 380. In the present example of a ground vector load being transmitted from the landing gear wheels to variable sensitivity load sensor 300, the compressive strain detected by strain gauges 372 would be indicative of the on-the-ground status of the aircraft providing, for example, an early indication of when the aircraft has transitioned from an in-the-air condition to an on-the-ground condition during a landing maneuver. Together, strain gauges 372 proximate the portion of flexure joint 310 in the direction of the radial load and strain gauges 372 proximate the portion of flexure joint 310 opposite the direction of the radial load may individually or collectively, such as in a Wheatstone bridge configuration, detect strains caused by changes in corresponding annular gap widths to provide an early indication of aircraft ground status.

In the event that variable sensitivity load sensor 300 experiences axial loads, such as loads in the leftward or rightward direction in FIG. 6A, gap 350 and/or gap 356 will tend to close responsive to the axial load. In the illustrated embodiment, gap 350 and gap 356 are sized to provide hard stops for annular sleeve 320 against lateral face 346 of inner nut 336 and/or annular shoulder 354 of inner ring 306. By limiting the axial movement of annular sleeve 320 relative to outer ring 306, excess stress on flexure joint 310 is prevented, thereby reducing the likelihood of damage or overload on flexure joint 310 when variable sensitivity load sensor 300 experiences axial loads.

While the variable sensitivity load sensors discussed herein have been described as having the capability of detecting initial loads applied thereto in aircraft landing implementations, the variable sensitivity load sensors of the present disclosure also have the capability of providing full weight on wheels functionality. It is noted that the detection of the initial landing load occurs as the width of upper annular gap is between its resting width and a closed state. This phase of sensor operations is considered to be in the minor radial load range in which the variable sensitivity load sensor is operating at a high sensitivity. This minor radial load range is best seen in FIG. 7 as the first linear slope 302 of strain versus load curve 300. In the illustrated embodiment, the minor radial load range is between one percent and four percent of the limit load of the variable sensitivity load sensor.

Once the upper annular gap has closed, this phase of sensor operations is considered to be in the major radial load range in which the variable sensitivity load sensor is operating at a low sensitivity. This major radial load range is best seen in FIG. 7 as the second linear slope 304 of strain versus load curve 300. In the illustrated embodiment, the major radial load range is between twenty percent and one hundred percent of the limit load of the variable sensitivity load sensor. The portion of the curve between the minor radial load range and the major radial load range may be considered the transition radial load range of the variable sensitivity load sensor which is denoted as 306 on strain versus load curve 300. In the illustrated embodiment, the transition radial load range is between four percent and twenty percent of the limit load of the variable sensitivity load sensor. In other embodiments, the minor radial load range could begin before or after one percent of the limit load and/or end before or after four percent of the limit load, depending upon the implementation. Likewise, the major radial load range could begin before or after twenty percent of the limit load, depending upon the implementation. The variable sensitivity load sensors of the present disclosure are useful in the major radial load range, for example, to determine the weight of the aircraft when it is on the ground. In addition, when data from variable sensitivity load sensors on each of the landing gear assemblies of an aircraft is collected, this can be used to determine the weight balance of the aircraft when it is on the ground. As such, the bilinear nature of the strain versus load curve enables the variable sensitivity load sensors of the present disclosure to have high sensitivity to loads in the minor radial load range and low sensitivity to loads in the major radial load range which is a beneficial combination for weight on wheels landing gear sensors as discussed herein.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A load sensor comprising:
a bearing housing having an inner ring, an outer ring and a flexure joint that integrally couples the inner ring to the outer ring;
an annular sleeve positioned between the inner ring and the outer ring, the annular sleeve coupled to one of the inner ring and the outer ring, the annular sleeve forming an annular gap with the other of the inner ring and the outer ring;
a bearing race positioned radially interiorly of the bearing housing;
a bearing element rotatably positioned within the bearing race; and
at least one strain gauge coupled to the flexure joint;
wherein, a width of the annular gap is changed responsive to a radial load applied to the bearing element such that the flexure joint and the at least one strain gauge are deformed, thereby providing an indication of the presence of the radial load.

2. The load sensor as recited in claim 1 wherein, the flexure joint has a curvilinear cross section.

3. The load sensor as recited in claim 1 wherein, the flexure joint has a uniform curvilinear cross section.

4. The load sensor as recited in claim 1 wherein, the annular sleeve is coupled to the inner ring and forms the annular gap with the outer ring.

5. The load sensor as recited in claim 4 wherein, the inner ring includes a shoulder; and
wherein, the annular sleeve is secured against the shoulder of the inner ring with a nut.

6. The load sensor as recited in claim 1 wherein, the annular sleeve is coupled to the outer ring and forms the annular gap with the inner ring.

7. The load sensor as recited in claim 1 wherein, the annular sleeve is a non-segmented annular sleeve.

8. The load sensor as recited in claim 1 wherein, the at least one strain gauge is coupled to a curved portion of the flexure joint.

9. The load sensor as recited in claim 1 wherein, the at least one strain gauge is coupled to a straight portion of the flexure joint.

10. The load sensor as recited in claim 1 wherein, the at least one strain gauge further comprises an array of redundant strain gauges.

11. The load sensor as recited in claim 1 wherein, the at least one strain gauge further comprises an array of complementary strain gauges.

12. The load sensor as recited in claim 11 wherein, the array of complementary strain gauges has a Wheatstone bridge configuration.

13. The load sensor as recited in claim 1 wherein, the width of the annular gap is reduced responsive to the radial load.

14. The load sensor as recited in claim 1 wherein, the width of the annular gap is expanded responsive to the radial load.

15. The load sensor as recited in claim 1 wherein, the at least one strain gauge further comprises at least one first strain gauge and at least one second strain gauge;
wherein, a width of a first portion of the annular gap is reduced responsive to the radial load such that the flexure joint and the at least one first strain gauge are deformed;
wherein, a width of a second portion of the annular gap is expanded responsive to the radial load such that the flexure joint and the at least one second strain gauge are deformed; and
wherein, the deformation of the at least one first strain gauge and the at least one second strain gauge collectively provide an indication of the presence of the radial load.

16. The load sensor as recited in claim 1 wherein, the at least one strain gauge further comprises an array of strain gauges distributed about the flexure joint, the array of strain gauges configured to provide directional load information.

17. The load sensor as recited in claim 1 further comprises a first sensitivity when the radial load is in a minor radial load range and a second sensitivity when the radial load is in a major radial load range;
wherein, the radial load transitions from the minor radial load range to the major radial load range when the radial load applied to the bearing element closes the annular gap in the direction of the radial load; and
wherein, the first sensitivity is higher than the second sensitivity.

18. A landing gear assembly for an aircraft having an airframe, the landing gear assembly comprising:
a landing strut including at least one wheel;
first and second trunnion bearings coupled to the airframe, the first and second trunnion bearings configured to pivotably receive the landing strut therebetween such that the landing strut has a plurality of positions relative to the airframe including a retracted position and an extended position;
at least one of the trunnion bearings forming an on-the-ground detection sensor, each on-the-ground detection sensor including:
a bearing housing having an inner ring, an outer ring and a flexure joint that integrally couples the inner ring to the outer ring;
an annular sleeve positioned between the inner ring and the outer ring, the annular sleeve coupled to one of the inner ring and the outer ring, the annular sleeve forming an annular gap with the other of the inner ring and the outer ring;
a bearing race positioned radially interiorly of the bearing housing;
a bearing element rotatably positioned within the bearing race; and
at least one strain gauge coupled to the flexure joint;
wherein, a width of the annular gap is changed responsive to a radial load applied to the bearing element such that the flexure joint and the at least one strain gauge are deformed, thereby providing an indication of the presence of the radial load.

19. An aircraft comprising:
an airframe including first and second spars;
a first trunnion bearing coupled to the first spar and a second trunnion bearing coupled to the second spar;
a landing strut including at least one wheel, the landing strut pivotable coupled between the first and second trunnion bearings such that the landing strut has a plurality of positions relative to the airframe including a retracted position and an extended position;
at least one of the trunnion bearings forming an on-the-ground detection sensor, each on-the-ground detection sensor including:
a bearing housing having an inner ring, an outer ring and a flexure joint that integrally couples the inner ring to the outer ring;
an annular sleeve positioned between the inner ring and the outer ring, the annular sleeve coupled to one of the inner ring and the outer ring, the annular sleeve forming an annular gap with the other of the inner ring and the outer ring;
a bearing race positioned radially interiorly of the bearing housing;
a bearing element rotatably positioned within the bearing race; and
at least one strain gauge coupled to the flexure joint;
wherein, a width of the annular gap is changed responsive to a radial load applied to the bearing element such that the flexure joint and the at least one strain gauge are deformed, thereby providing an indication of the presence of the radial load.

20. The aircraft as recited in claim 19 wherein, the aircraft is a rotorcraft.
